(19) United States
(12) Patent Application Publication
(10) Pub. No.: US 2006/0164243 A1
(43) Pub. Date: Jul. 27, 2006

(54) Theft prevention retaining element

(76) Inventor: Reinhold Ott, Ontario (CA)

Correspondence Address: HARNESS, DICKEY & PIERCE, P.L.C., P.O. BOX 8910, RESTON, VA, 20195, US

(21) Appl. No.: 10/532,231

(22) PCT Filed: Oct. 23, 2003
(86) PCT No.: PCT/EP03/11741

§ 371 Date: Jan. 18, 2006

(30) Foreign Application Priority Data
Oct. 24, 2002 (DE) 102 49 460.6

(51) Int. Cl. G08B 13/14

(52) U.S. Cl. 340/571

(57) ABSTRACT

The invention relates to a retaining element (1) for protecting a product (2) from theft. Said retaining element (1) comprises a first retaining area (3), in particular, for fastening the retaining element (1) to a fastening element (4) and comprises at least one second retaining element (5), in particular, for fastening the retaining element (1) to the product (2). The second retaining area (5) is designed so that it can be deformed more easily than the first retaining area (3) whereby enabling the retaining element (1) to be optimally adapted to the shape of the product (2). In addition, the retaining element (1) can be placed on the product (2) by means of a double-sided adhesive tape. This adhesive tape is designed so that it can be stretched.

The present invention relates to a retaining component for securing an item from theft, wherein the retaining component comprises a first retaining area in particular for fastening the retaining component to a fastening component, and at least one second retaining area in particular for fastening the retaining component to the item, wherein the second retaining area is designed such that it can be deformed more easily than the first retaining area, and wherein the retaining component can be attached to the item using a double-sided adhesive strip.

The present invention beyond that relates to a fastening component for a retaining component, as well as an alarm system with a retaining component and a fastening component.

In familiar alarm systems, which are used for example in department stores or other show rooms in order to protect a displayed product from theft, the retaining component is often fastened with specifically provided surface elements to the item that is to be secured. Assembly of the surface elements is complex and increases production costs.

Surface elements that are seated in the retaining component by means of ball joints require particularly high manufacturing expenditures. Said surface elements allow a retaining component equipped with them to also be attached to round objects. Apart from the high manufacturing expenditures, especially also the size of such a retaining component is too large for many types of products to be presented. For the visually appealing presentation of the item it is necessary that the retaining component has a relatively small size.

From U.S. Pat. No. 5,565,848 A the use of a body made of rubber-like material is known, which can be adjusted to the item that is to be secured.

It is the object of the present invention to further develop a retaining component for securing items as well as an alarm system comprising a retaining component such that a simple and appealing presentation of the items is possible, and that simultaneously the retaining component can be attached as easily as possible to the items.

In a retaining component of the above-mentioned kind this object is achieved pursuant to the invention in that the double-sided adhesive strip has a ductile design.

This way the adhesive strip can adjust without difficulty to any arching of the item that is to be secured. Hence, when the retaining component is glued to the item using the adhesive strip, a firm connection is established between the retaining component and the item—even when the surface onto which the retaining component is glued is arched. This is accomplished on the one hand by the deformability of the retaining component, and on the other hand by the ductility of the adhesive strip.

Furthermore, it is possible to pull the adhesive strip off laterally due to its ductility so that it detaches roughly simultaneously from the retaining component and the item. Preferably an alarm is then triggered by the expansion and/or detachment.

Especially when using a so-called “Tesa-Power-Strip” adhesive tape, in this case the adhesive strip detaches without residue from the retaining component and the item. Hence it is possible to reuse the retaining component. To do so, it is only necessary to attach the retaining component by means of a new double-sided adhesive strip on the same or another item.

With respect to the design of the retaining component it is possible to adjust the second retaining area e.g. to rounded or round outer surfaces of objects to be displayed, while the first retaining area has sufficient stability for fastening the retaining component to the fastening component.

A very beneficial embodiment of the retaining component pursuant to the invention is characterized in that the first retaining area and the second retaining area consist of the same material so that especially the manufacture is simplified and hence production costs are lowered. This eliminates for example the high assembly efforts required for connecting the surface elements to the retaining component in the case of surface elements that are seated in ball joints.

It is especially beneficial when the first retaining area and the second retaining area are an integral part of the retaining component so that no assembly is required any longer to connect the first retaining component to the second one. The retaining component preferably consists of elastically deformable material, for example plastic.

Pursuant to another very beneficial embodiment of the present invention, the material thickness of the second retaining area is less than the material thickness of the first retaining area, thus achieving easier deformability of the second retaining area as compared to the first retaining area. The material thickness in the first retaining area should be selected such, that stable attachment of the retaining component to the fastening component is guaranteed, whereas the material thickness in the second retaining area should be selected such, that the retaining component in the second retaining area can also be adjusted to round surfaces.

It is also conceivable to provide for a tapering of the retaining component in the first retaining area, especially between the first retaining area and the second one so that also areas of the first retaining component facing the products are designed with sufficient flexibility, and can hence be adjusted to any random product shapes.

Pursuant to another embodiment of the present invention it is especially beneficial to provide an adhesive layer in the second retaining area for the purpose of fastening the retaining component to the items. The adhesive layer can consist for example of double-sided adhesive tape, as available for example under the commercial term “Tesa-Power-Strip” from the company Beiersdorf.

It is also possible to attach the adhesive layer on the entire surface of the retaining component facing the item, i.e. also on the areas of the first retaining component facing the item, to the extent that these should also come in contact with the item. This way even better adhesion of the retaining component to the item can be achieved.

Another embodiment of the present invention provides that the retaining component can be connected detachably to the fastening component and in particular can be snapped and/or clamped and/or hung into the fastening component. This way, simple attachment of the retaining component to the fastening component is possible, where the retaining component including the items remain as long as a customer does not seize the product.

Pursuant to another embodiment of the present invention it is especially beneficial that the retaining component comprises sensor means for monitoring the proper fastening of the retaining component to the item. The sensor means can e.g. be integrated in the adhesive layer, and are preferably designed as resistive/capacitive switches, or also as optical sensor means.

Especially beneficial is a design of the sensor means as electric sensor means, wherein an electric conductor loop is formed in the area of the adhesive layer, which is interrupted during an attempt to separate the item from the retaining component attached to it or from the adhesive layer.

For the purpose of evaluating such attempted theft an evaluation circuit is provided, which is connected to the sensor means via electric connecting devices. The evaluation circuit can for example be provided in the retaining component.

Another embodiment of the present invention provides that the evaluation circuit is accommodated in the fastening component. Here, it is especially expedient that the sensor means of the retaining component are connected to the evaluation circuit via a cable.

Additionally or alternatively thereto it is possible to use mechanical connecting devices for connecting the retaining component to the fastening component. The mechanical connecting devices can, for example be designed as wires.

In order to allow for the most appealing presentation of the displayed items, it is suggested pursuant to another embodiment of the present invention to integrate the connecting devices in the fastening component preferably such, that they can be rolled up. For this purpose it is beneficial to integrate a winding device for the connecting devices in the fastening component. Such a winding device can be designed for example in the form of a cable reel or the like. The respective electric or mechanical connecting device that is to be rolled up should in this case be designed such that it has a small size, i.e. the smallest possible cross-section.

Contact of the electric connecting devices in the winding device is possible for example via ball contacts.

As another solution to the object of the present invention, an alarm system comprising a retaining component pursuant to the invention is suggested.

In another very beneficial embodiment of the invention, the retaining component is detachably connected to the electric and/or mechanical connecting devices. An electric connecting cable, which connects e.g. the sensor means of the retaining component to an evaluation circuit located in the fastening component, can be detachably connected to the retaining component for example via a plug.

Further features, application possibilities and advantages of the invention result from the following description of exemplary embodiments of the invention, which are illustrated in the figures of the drawing. All described or illustrated features form either alone or in any random combination the object of the invention, regardless of their composition in the patent claims or their reference to others, as well as regardless of their formulation and/or illustration in the description and/or drawing.

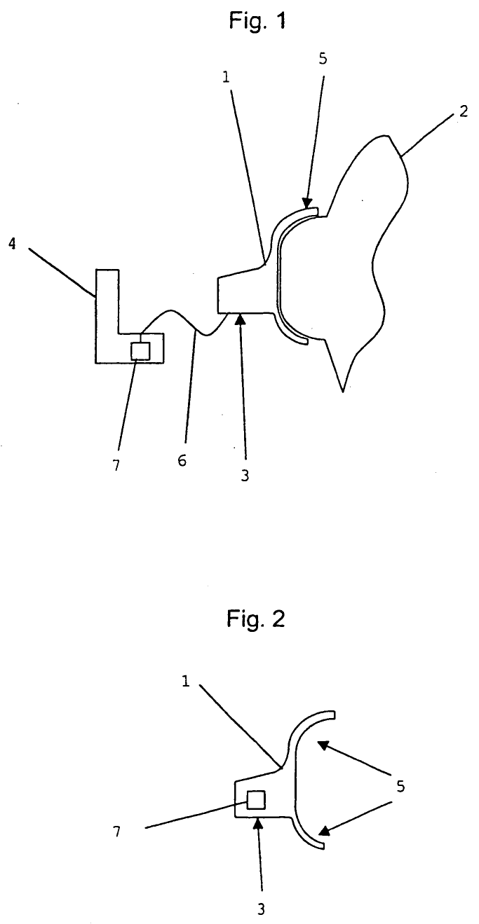

FIG. 1 shows diagrammatically a retaining component pursuant to the invention in a side view; and

FIG. 2 shows diagrammatically another embodiment of the retaining component pursuant to the invention.

The retaining component 1 comprises a first retaining area 3, which serves for fastening the retaining component 1 to a fastening component 4 on the one hand, as well as fastening the retaining component 1 to an item 2. The retaining component 1 furthermore comprises a second retaining area 5, which is provided for additionally fastening the retaining component 1 to the item 2. Only a portion of item 2 is illustrated in FIG. 1.

Attachment of the retaining component 1 to the fastening component 4 occurs by means of a combined hanging and snap mechanism, where for the purpose of being attached to the fastening component 4 the retaining component 1 is initially hung into the fastening component 4 and then snapped in while applying slight pressure. This way the retaining component 1 including the item 2 is held securely by the fastening component 4, and can be removed again from the fastening component 4 by unlatching the snap mechanism.

As is evident from FIG. 1, the material thickness of the retaining component 1 in the second retaining area 5 is less than the material thickness of the retaining component 1 in the first retaining area 3, wherein the second retaining area 5 has an areal design, and the material thickness is roughly constant across the entire second retaining area 5.

Both the first retaining area 3 and the second retaining area 5 are an integral part of the retaining component 1, i.e. in the retaining component 1 pursuant to the invention no assembly is required, as is required in conventional retaining components for example to fasten the surface elements coming in contact with the items 2 to the retaining component 1.

Due to the lower material thickness in the second retaining area 5, the retaining component 1 in the second retaining area 5 can be deformed more easily than in the first retaining area 3. This way a secure attachment of the retaining component 1 to the fastening component 4 is possible, while the retaining component 1 at the same time can be adjusted to nearly any randomly rounded items 2 due to the elastic deformation of the second retaining area 5. The good adaptability to the shape of the item makes it possible to maximize the contact surface between the retaining component 1 and the item 2, thus ensuring a secure connection when using an adhesive layer (not shown) between the retaining component 1 and the item 2.

It is especially beneficially when a double-sided adhesive tape having a flexible and ductile design is used as the adhesive layer. Such an adhesive tape has a thickness of about 1 mm and has soft material qualities. Preferably the double-sided adhesive tape distributed by the company Beiersdorf under the commercial name “Tesa-Power-Strip” may be used.

In order to detect an attempted theft, the retaining component 1 is equipped with electric sensor means (not shown), which are integrated in the adhesive layer and monitor the retaining component 1 for proper attachment to the item 2. The sensor means are designed as switches, especially also multi-part conductor loops e.g. consisting of film conductors, or also electrically conductive layers on the adhesive layer, which are opened during attempts to steal the item 2.

Due to their generally high sensitivity, also capacitive sensors are suited, either alone or in combination with resistive sensors, for monitoring the item 2. Furthermore, it is possible to use optical sensors.

For alarm signaling purposes, the sensor means are connected via a thin cable 6 to an evaluation circuit 7, which is arranged in the fastening component 4. The evaluation circuit 7 is battery-operated and therefore also allows for items to be secured in locations without additional electric power supply, such as the electric network.

The evaluation circuit 7 recognizes the opening of the switches integrated in the adhesive layer and issues an optical and an acoustic warning signal via a piezo sound converter and a signal lamp.

For the cable 6 a winding device (not shown) following the principle of a cable reel is provided in the fastening component 4, winding the cable 6 up when not in use. This way the cable 6 is not suspended freely in a presentation surface surrounding the item 2, which would impair the visual impression of the presented item 2. Contacting of the cable 6 in the winding device occurs likewise via ball contacts, which are not shown, either.

As soon as the item 2 including the retaining component 1 is detached from the fastening component 4, e.g. in order to be viewed by an interested party, the cable 6 is rolled off the winding device. This way the retaining component 1 and/or the sensor means contained therein always remain connected to the evaluation circuit 7, so that continuous monitoring of the item 2 is guaranteed.

The simple design of the retaining component 1 allows for an inexpensive production, for example using the injection molding process, and furthermore allows for an environmentally compatible disposal of the retaining component 1, for which no separation of materials is required since it consists of only one material.

The different material thickness levels in the various areas 3, 5 of the retaining component 1 at the same time guarantee high stability for the attachment of the retaining component 1 to the fastening component 4, and easy deformability for optimal adjustment to the item 2. Beyond that it is also feasible to attach the retaining component 1 to a plane surface of an item.

For different application areas/item sizes a corresponding geometry of the second retaining area 5 of the retaining component 1 is conceivable. The second retaining area 5 can e.g. have a rectangular or round shape or also consist of several segments that are arranged radially around the first retaining area 3.

The double-sided adhesive tape can be easily adapted to all possible shapes, especially of the second retaining area 5 of the retaining component 1, due to its simple packaging. To attach it, the double-sided adhesive tape must only be glued onto the surface of the retaining component 1 facing the item 2, whereupon the retaining component 1 is attached to the item 2 with the double-sided adhesive tape. Due to its ductility, the double-sided adhesive tape adapts automatically to any arching of the item 2.

During an attempted theft it is possible to pull off the double-sided adhesive tape to the side, i.e. roughly in the plane of the adhesive tape as such or roughly parallel thereto. Such a procedure is possible due to the ductile characteristics of the adhesive tape. This means that the adhesive tape detaches roughly simultaneously and evenly from the item 2 and the retaining component 1. This is due to the fact that the expansion progresses practically identically on both sides of the adhesive tape because of the low material thickness of the adhesive tape and hence the detaching process occurs practically simultaneously and evenly. The expansion and/or detachment of the adhesive tape then in turn cause the afore-mentioned switch, i.e. for example a conductor loop that is integrated in the adhesive layer, to be opened, which triggers an alarm.

Additionally the double-sided adhesive tape can be equipped with a handling area, which is located outside the surface formed by the retaining component 1 and where the adhesive tape has no adhesive properties.

For example, the adhesive tape can be equipped there with a film on both sides. In this handling area, the adhesive tape can then be held and—as explained—be pulled off to the side.

Thereby, the handling area is preferably provided for an operator, who is supposed to attach the retaining component 1 for example to another item 2. The operator can then hold the double-sided adhesive tape to the handling area and pull it off to the side. This triggers an alarm, however, in this case it can be turned off again for example by the operator since it does not involve a case of attempted theft.

Thereafter the double-sided adhesive tape can be detached completely from the retaining component 1 and the item 2. When using a “Tesa-Power-Strip” or a comparable adhesive tape, the adhesive layer can generally be removed from the item 2 and also from the retaining component 1 without residue.

Thereafter, the retaining component 1 can be attached to a different item 2 with a new double-sided adhesive tape.

When the handling area is used during attempted theft to pull the adhesive tape off to the side, an alarm is triggered—as described. After an operator has checked the alarm, in this case also the retaining component 1 can be attached to the same or another item 2 using a new double-sided adhesive tape.

In another embodiment of the invention, which is illustrated in FIG. 2, the evaluation circuit 7 is provided directly in the retaining component 1. The evaluation circuit is preferably attached in the first retaining area 3. In this case it is conceivable that no electric cable connection is provided between the retaining component 1 and the fastening component 4, but instead only a mechanical connection, for example using a thin wire cable (not shown) or the like.

Another embodiment of the invention provides that the retaining component 1 (FIG. 1) be connected detachably to the fastening component 4. Such a detachable connection can be formed for example by a plug-type connector between the cable 6 (FIG. 1) and the retaining component 1.

Overall, with an alarm system containing the inventive retaining component 1 and the fastening component 4 a simple and appealing presentation of the item 2 is possible with simultaneous easy attachment of the retaining component 1 to the item 2.

1. Retaining component for securing an item from theft, the retaining component comprising: a first retaining area for fastening the retaining component to a fastening component; and at least one second retaining area in for fastening the retaining component to the item, the second retaining area being designed to be more easily deformable than the first retaining area, wherein the retaining component is attachable to the item using a double-sided adhesive strip and includes an elastically deformable material, the double-sided adhesive tape being ductile.

2. Retaining component as claimed in claim 1, wherein an expansion of the double-sided adhesive tape leads to a roughly simultaneously occurring detachment of the same from the retaining component and the item.

3. Retaining component as claimed in claim 2, wherein at least one of the expansion and the detachment of the double-sided adhesive tape triggers an alarm.

4. Retaining component as claimed in claim 1, wherein the double-sided adhesive tape is equipped with a non-adhesive handling area.

5. Retaining component as claimed in claim 1, wherein the double-sided adhesive tape can be pulled off laterally, especially using a.

6. Retaining component as claimed in claim 1 wherein the double-sided adhesive tape involves a product from Tesa company, which is distributed under the term Power Strip.

7. Retaining component as claimed in claim 1, wherein the first retaining area and the second retaining area include the same material.

8. Retaining component as claimed in claim 1, wherein the first retaining area and the second retaining area are an integral part of the retaining component.

9. Retaining component as claimed in claim 1, wherein the material thickness of the second retaining area is less than the material thickness of the first retaining area.

10. Retaining component as claimed in claim 1, wherein in the second retaining area an adhesive layer is provided for attaching the retaining component to the item.

11. Retaining component as claimed in claim 1, wherein the attachment of the retaining component to the fastening component is detachable.

12. Retaining component as claimed in claim 1, wherein the retaining component comprises sensor elements for monitoring proper fastening of the retaining component to the item.

13. Retaining component as claimed in claim 1, wherein the sensor elements are designed as electric sensor elements.

14. Retaining component as claimed in claim 12 wherein electric connecting devices are provided for electrically connecting the sensor elements to an evaluation circuit.

15. Retaining component as claimed in claim 12, wherein an evaluation circuit is provided in the retaining component.

16. Retaining component as claimed in claim 1, wherein mechanical connecting devices are provided for connecting the retaining component to the fastening component.

17. Retaining component as claimed in claim 16, wherein the connecting devices are designed as wires or cables.

18. Retaining component as claimed in claim 14, wherein the connecting devices are integratable in the fastening component.

19. Fastening component for a retaining component of claim 18, wherein the fastening component includes a winding device for the connecting devices.

20. Fastening component for a retaining component of claim 14, wherein the evaluation circuit is arranged in the fastening component.

21. Fastening component as claimed in claim 19, wherein the electric connecting devices are contactable via ball contacts in the winding device.

22. Alarm system comprising a retaining component as claimed in claim 1 and a fastening component for fastening the retaining component.

23. Retaining component as claimed in claim 1, wherein the double-sided adhesive tape can be pulled off laterally using a force that is applied on the adhesive tape and that acts upon it roughly in the plane of the adhesive tape.

24. Retaining component as claimed in claim 1, wherein the sensor elements are designed as at least one of capacitive switches, and as optical sensor elements.

25. Retaining component as claimed in claim 13, wherein electric connecting devices are provided for electrically connecting the sensor elements to an evaluation circuit.

26. Retaining component as claimed in claim 13, wherein an evaluation circuit is provided in the retaining component.

27. Retaining component as claimed in claim 24, wherein electric connecting devices are provided for electrically connecting the sensor elements to an evaluation circuit.

28. Retaining component as claimed in claim 24, wherein an evaluation circuit is provided in the retaining component.
